(19) United States
(12) Patent Application Publication
(10) Pub. No.: US 2017/0238252 A1
(43) Pub. Date: Aug. 17, 2017

(54) ENABLING POWER EFFICIENT DUAL CONNECTIVITY WITH REDUCED DELAY IMPACT

(71) Applicant: Nokia Technologies Oy, Espoo (FI)

(72) Inventors: Lars DALSGAARD, Oulu (FI); Jorma KAIKKONEN, Oulu (FI); Petteri LUNDEN, Espoo (FI); Elena VIRTEJ, Espoo (FI)

(21) Appl. No.: 15/518,463

(22) PCT Filed: Oct. 24, 2014
(86) PCT No.: PCT/IB2014/065600

§ 371 Date: Apr. 11, 2017

(51) Int. Cl. H04W 52/02; H04W 16/32; H04W 74/08; H04W 24/08; H04W 76/04; H04W 76/02

(52) U.S. Cl. CPC H04W 52/0216; H04W 76/048; H04W 76/025; H04W 74/0833; H04W 24/08; H04W 16/32

(57) ABSTRACT

In accordance with the exemplary embodiments of the invention there is at least an apparatus and method to receive from a first access node an indication of a communication required by a second access node with the user equipment, where the user equipment is connected to both the first access node and the second access node; and in response to the indication, trigger at the user equipment a connectivity operation with the second access node. In accordance with the exemplary embodiments of the invention there is at least an apparatus and method to receive from a second access node, by a first access node, signaling indicating that a communication is required with a user equipment by the second access node; and in response to the signaling, send by a first access node to the user equipment a command to monitor a connection with the second access node for the required communication.

### TECHNICAL FIELD

The teachings in accordance with the exemplary embodiments of this invention relate generally to a method and apparatus to increase a power saving efficiency of a communication device and, more specifically, relate to improving and optimising control of discontinuous reception periods of a communication device that is connected to more than one carrier.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In communication systems such as 3GPP LTE/LTE-A systems, a discontinuous reception (DRX) period is implemented to support a low power or sleep mode during RRC Connected state while there is no data transmission. It is observed that DRX might have a trade-off between data latency and UE power consumption. For example, using long DRX may have low power consumption but increase the latency. As a result, switching of DRX configurations based on different traffic requirements can help improve the low power or sleep mode benefits from DRX. Still, the timing or a delay of control signaling for the DRX feature can have significant impact on the overall system performance. At least these issues are addressed herein.

Certain abbreviations that may be found in the description and/or in the Figures are herewith defined as follows:
ARQ automatic repeat request
BSR buffer status report
CA carrier aggregation
CC component carrier
DC dual connectivity
DRX discontinuous reception
eNB base station
RLF radio link failure
HARQ hybrid ARQ
HOF handover failure
KPI key performance indicator
LTE long term evolution
LTE-U LTE-unlicensed
LAA licensed assisted access
MAC medium access control
NW network
PDCCH physical downlink control channel
MeNB master eNB
RACH random access channel
RACH/SR random access channel scheduling request
RLF radio link failure
RRC radio resource control
RTT round trip time
SeNB secondary eNB
SCG service continuity gateway
SEN system frame number
SR scheduling request
TAT time alignment timer
TP throughput
UL uplink
UE user equipment
PCell primary cell
PSCell primary secondary cell
PUCCH physical uplink control channel

### SUMMARY

In an exemplary aspect of the invention, there is a method comprising receiving by a user equipment from a first access node an indication of a communication required by a second access node with the user equipment, where the user equipment is connected to both the first access node and the second access node; and in response to the indication, triggering at the user equipment a connectivity operation with the second access node.

In another exemplary aspect of the invention, there is an apparatus comprising means for receiving by a user equipment from a first access node an indication of a communication required by a second access node with the user equipment, where the user equipment is connected to both the first access node and the second access node; and means, in response to the indication, for triggering at the user equipment a connectivity operation with the second access node.

In another exemplary aspect of the invention, there is a method comprising receiving from a second access node, by a first access node, signaling indicating that a communication is required with a user equipment by the second access node; and in response to the signaling, sending by a first access node to the user equipment a command to monitor a connection with the second access node for the required communication.

In still another exemplary aspect of the invention, there is an apparatus comprising means for receiving from a second access node, by a first access node, signaling indicating that a communication is required with a user equipment by the second access node; and means, in response to the signaling, for sending by a first access node to the user equipment a command to monitor a connection with the second access node for the required communication.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows operation in a dual connectivity scenario in accordance with the exemplary embodiments;

FIG. 2 shows a simplified block diagram of devices configured to perform operations in accordance with the exemplary embodiments of the invention;

FIG. 3 shows different signaling in accordance with the exemplary embodiments of the invention;

FIG. 4 shows at least a potential latency reduction when applying a method in accordance with the exemplary embodiments of the invention; and

FIGS. 5A and 5B each show a method in accordance with the exemplary embodiments which may be performed by an apparatus.

### DETAILED DESCRIPTION

In this invention, we propose at least a method and an apparatus which can be used to improve and optimize control of discontinuous reception periods of a communication device that is connected to more than one carrier.

Dual Connectivity is currently being standardized in 3GPP. Dual Connectivity can be applied by a UE which has at least 2 DL and 2 UL capability. When defining DC there is a need to go through the UE requirements concerning measurement and monitoring rules. Additionally it is important to analyze the DC from a mobility and signaling point of view in order to analyze if there are possible need for improving the existing behavior or if DC can be used to enhance certain procedures. In the following we look at how to ensure or even improve the UE power savings while at the same time ensure signaling robustness in DC.

In accordance with 3GPP specifications the UE can be configured [by RRC/MAC] with a DRX functionality that allows the UE to stop monitoring PDCCH during some period of time. The DRX functionality consists of a Long DRX cycle, a DRX Inactivity Timer, a DRX Retransmission Timer and optionally a Short DRX Cycle and a DRX Short Cycle Timer. When a DRX cycle has been configured, the UE shall for each TTI: whenever a new DRX Cycle begins, the On Duration Timer is started. If a DL assignment has been configured for this TTI start the HARQ RTT Timer. If the On Duration Timer or DRX Inactivity Timer or DRX Retransmission Timer is running; or if an UL grant for a retransmission can occur: UE shall monitor the PDCCH; if the PDCCH is successfully decoded: if the PDCCH indicates a DL transmission: start the HARQ RTT Timer. If On Duration Timer or DRX Inactivity Timer is running and the PDCCH indicates a new transmission: start or restart the DRX Inactivity Timer. If the DRX Inactivity Timer expires in this TTI: start DRX Short Cycle Timer if configured; use the short DRX cycle if configured else use the long DRX cycle. If DRX Short Cycle Timer or the On Duration Timer expires in this TTI: use the long DRX cycle. If HARQ RTT Timer expires in this TTI: UE shall start or restart the DRX Retransmission Timer. It is noted that whether or not the UE is monitoring PDCCH the UE receives and transmits HARQ feedback when expected. To date these operations are configured for example using control data and/or based on a device load, or traffic type or traffic profile. The exemplary embodiments optimize the DRX operation dynamically based at least on communication needs of the devices.

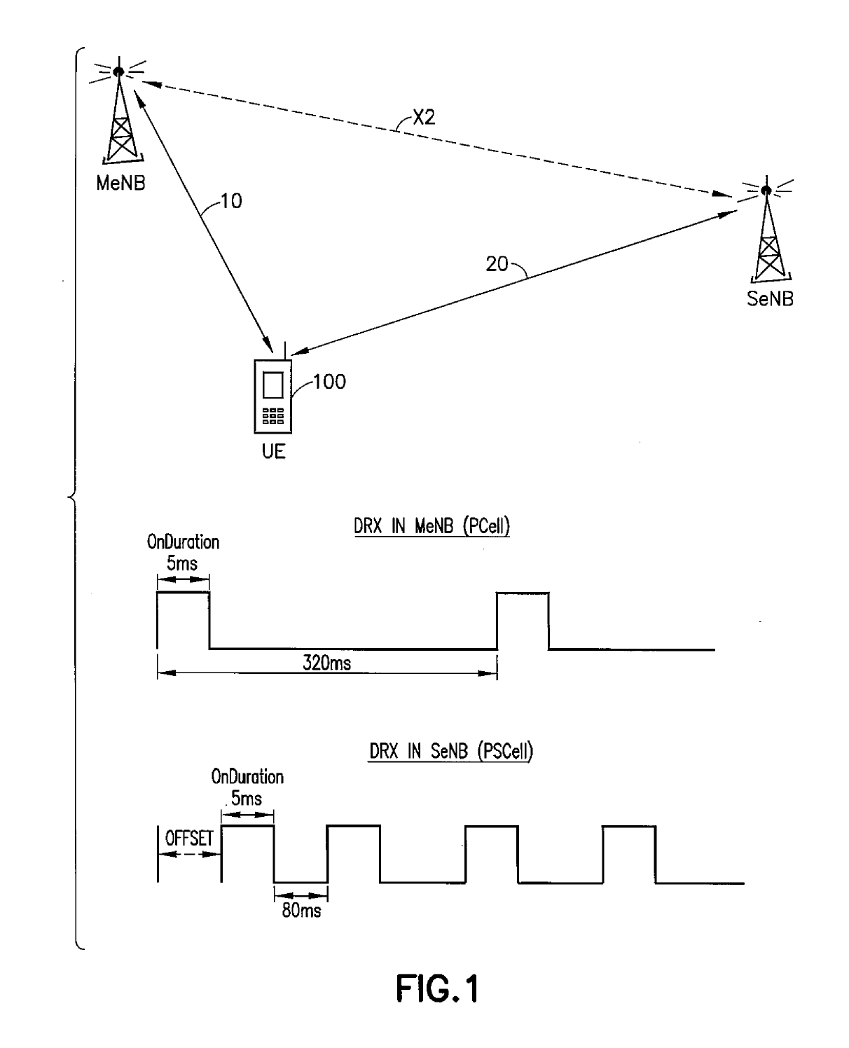

FIG. 1 is an illustration of dual connectivity by a UE in accordance with the exemplary embodiments. The UE 100 is connected to the MeNB (PCell) via link 10 and the UE 100 is connected to the SeNB (PSCell) via link 20. As shown with the DRX in MeNB and the DRX in SeNB diagrams of FIG. 1 it can be seen that the PCell and PSCell have configured two different independent DRX cycles. As shown in FIG. 1 the MeNB cell is configured with a DRX cycle of 320 ms including the OnDuration timer whereas the SeNB cell is configured with a DRX cycle of 80 ms including the OnDuration timer. During the OnDuration timer the UE may be required to monitor a carrier for PDCCH. In addition as shown with the DRX in SeNB diagram of FIG. 1 there is drxStartOffset for the PSCell. The PSCell may be the cell in SeNB that carries PUCCH. The drxStartOffset specifies the subframe where the DRX Cycle or the DRX OnDuration starts.

Standards submissions have included that the DRX configuration be independent for PCell and PSCell. This can enable a potential for good UE power savings as for example a network can configure user equipment (UE) to have long DRX for the cases when the data activity on one component carrier (CC) is low or non-existent. For example this could be the case where the dual connectivity (DC) is used for offloading purposes and a primary secondary cell (PSCell) is the cell used for possibly very large data volumes while the primary cell (PCell) is used to ensure robust connection to the network. In this regards it is noted that the PSCell may have been configured with the shorter 80 ms DRX cycle as illustrated in FIG. 1 for the purpose of offloading traffic, e.g., in an SGC scenario, from the UE to the PSCell such due to heavier traffic at the Pcell.

To benefit from the power saving opportunities as potentially due to control signaling the DRX length is extended towards longer DRX cycles in the PCell there will be an increased delay in the PCell DL transmission. Due to such control signaling coming from the PCell (as per 3GPP agreements)—including PSCell configuration changes—this increased delay can adversely impact a DC functionality or mobility robustness of the UE.

Delays in the control signaling can have significant impact on the overall system performance. It may lead to use of suboptimal configurations being applied for too long time, it may reduce the network re-configuration opportunities, may reduce the network response time, and may also impact the user data TP. Any of these can potentially lead to the network not being able to utilize the air interface resources in an optimal manner. Further, when the NW tries to minimize the delays by keeping configured DRX parameters on PCell this also can be sub-optimal from a generic data activity and power saving perspective. Just to mention some examples. The Exemplary embodiments of the invention enable the power savings benefit with the use of a longer DRX cycle configuration at a cell such as the PCell, without the negative impacts of the increased delay, such as described herein.

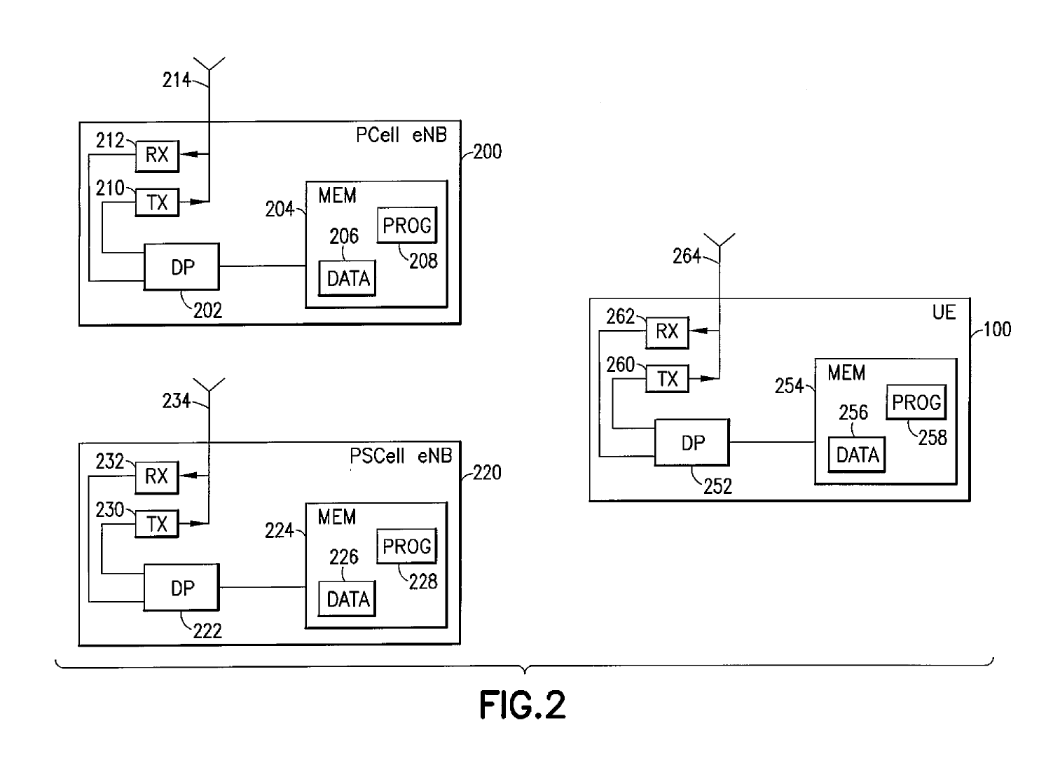

Before describing the exemplary embodiments of the invention in further detail reference is now made to FIG. 2. FIG. 2 illustrates a simplified block diagram of base stations such as a PCell eNB 200 and a PSCell eNB 220, and a user device, such as a UE 100, suitable for use in practicing the exemplary embodiments of this invention. In FIG. 2 apparatuses, such as the PCell eNB 200 and the PSCell eNB 220, are adapted for communication with other apparatuses having wireless communication capability, such as the UE 100. In addition, it will be recognized that the designations of the PCell eNB 200 and the PSCell eNB 220 as “PCell” and “PSCell” are made with respect to a specific UE, such as the UE 100 and are not made based on any particular hardware or software configurations of the devices themselves. With respect to other UEs, the eNB 200 may easily be designated as a PSCell 200 and the eNB 220 may just as easily be designated as a PCell 200.

The eNB 200 includes processing means such as at least one data processor (DP) 202, storing means such as at least one computer-readable memory (MEM) 204 storing data 206 and at least one computer program (PROG) 208 or other set of executable instructions, communicating means such as a transmitter TX 210 and a receiver RX 212 for bidirectional wireless communications with the UE 250 via an antenna 214.

The eNB 220 includes processing means such as at least one data processor (DP) 222, storing means such as at least one computer-readable memory (MEM) 224 storing data 226 and at least one computer program (PROG) 228 or other set of executable instructions, communicating means such as a transmitter TX 230 and a receiver RX 232 for bidirectional wireless communications with the UE 100 via an antenna 234.

The UE 100 includes processing means such as at least one data processor (DP) 252, storing means such as at least one computer-readable memory (MEM) 254 storing data 256 and at least one computer program (PROG) 258 or other set of executable instructions, communicating means such as a transmitter TX 260 and a receiver RX 262 for bidirectional wireless communications with the eNB 200 or the eNB 220 via one or more antennas 264. UE capable of dual connectivity may have multiple transmitters TX and receivers RX to enable simultaneous communication with eNB 200 and eNB 220. In addition, it is noted that although FIG. 2 may only illustrate one transmitter TX and one receiver RX in the eNB 200, the eNB 220, or the UE 100 this is non-limiting in accordance with the exemplary embodiments and these devices can each be configured to simultaneously support multiple RX and/or TX communications or chains with multiple devices. In accordance with the exemplary embodiments the data 206, 226, and/or 256 may include data required to implement a method and operate an apparatus in accordance with the exemplary embodiments of the invention.

At least one of the PROGs 208 in the eNB 200 is assumed to include a set of pro gram instructions that, when executed by the associated DP 202, enable the device to operate in accordance with the exemplary embodiments of this invention, as detailed above. In these regards the exemplary embodiments of this invention may be implemented at least in part by computer software stored on the MEM 204, which is executable by the DP 202 of the eNB 200, or by hardware, or by a combination of tangibly stored software and hardware (and tangibly stored firmware).

Similarly, at least one of the PROGs 228 in the eNB 220 is assumed to include a set of program instructions that, when executed by the associated DP 222, enable the device to operate in accordance with the exemplary embodiments of this invention, as detailed above. In these regards the exemplary embodiments of this invention may be implemented at least in part by computer software stored on the MEM 224, which is executable by the DP 222 of the eNB 220, or by hardware, or by a combination of tangibly stored software and hardware (and tangibly stored firmware).

Similarly, at least one of the PROGs 258 in the UE 100 is assumed to include a set of program instructions that, when executed by the associated DP 252, enable the device to operate in accordance with the exemplary embodiments of this invention, as detailed above. In these regards the exemplary embodiments of this invention may be implemented at least in part by computer software stored on the MEM 254, which is executable by the DP 252 of the UE 100, or by hardware, or by a combination of tangibly stored software and hardware (and tangibly stored firmware). Electronic devices implementing these aspects of the invention need not be the entire devices as depicted at FIG. 2 or may be one or more components of same such as the above described tangibly stored software, hardware, firmware and DP, or a system on a chip SOC or an application specific integrated circuit ASIC.

In general, the various embodiments of the UE 100 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEM 204, 224, and 254 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 202, 222, and 252 include but are not limited to general purpose computers, special purpose computers, microprocessors, digital signal processors (DSPs) and multi-core processors.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

In accordance with the exemplary embodiments of the invention there is a method and an apparatus which enables use of long DRX on PCell without introducing the negative impact from having increased DL delay in PCell. The exemplary embodiments of the invention enable an eNB such as the PSCell to indicate to a UE that the UE shall initiate PDCCH monitoring on a carrier of another eNB such as a PCell, or vice versa.

The indication would ensure that the UE enables the PCell reception and start monitoring the PDCCH on the PCell. In accordance with the exemplary embodiments the network would indicate to the UE to wake up/start the PCell monitoring due to PCell having some signaling for the UE on the PCell. The signaling can for example include control signaling such as a handover command and/or new configuration signaling, and/or in some cases possibly user data. The monitoring could be continuous or for example follow the short DRX cycle given in the PCell DRX configuration, or some other pattern/cycle informed to the UE.

In order to reduce delay without forcing network to configure the UE with continuous short DRX cycle on PCell there would be a command (e.g. MAC or PDCCH) on PSCell that is used to trigger the UE to:
Monitor PCells PDCCH for a time period (e.g. predetermined time, x time) (e.g. for a PDCCH order)—for example a new timer could be defined for it and UE could be configured with that (using RRC reconfiguration); alternatively, existing DRX timers such as OnDuration timer could be used; and/or
Initiates/start RACH/SR on PCell (Indicating PCell: I'm here now . . . )

This will enable network to send the control signaling (and possibly also user data) to UE from the PCell with reduced delay (latency reduction) while still enabling improved UE power saving due to enabling very long PCell DRX.

Note that this could be also considered in a case when the cells are more equal, for example a PSCell (secondary eNB) requesting a PCell (primary eNB) to wake-up the UE.

When PCell has something to transmit to UE, it will signal PSCell (e.g. over X2) and PSCell will signal UE to listen to PCell. PCell provides the required information to PSCell to trigger the transmission of the monitoring command for the UE. The information exchange process needs to consider the X2 delay, but yet in case of DC, this delay is typically not very high, in range of 2-20 ms.

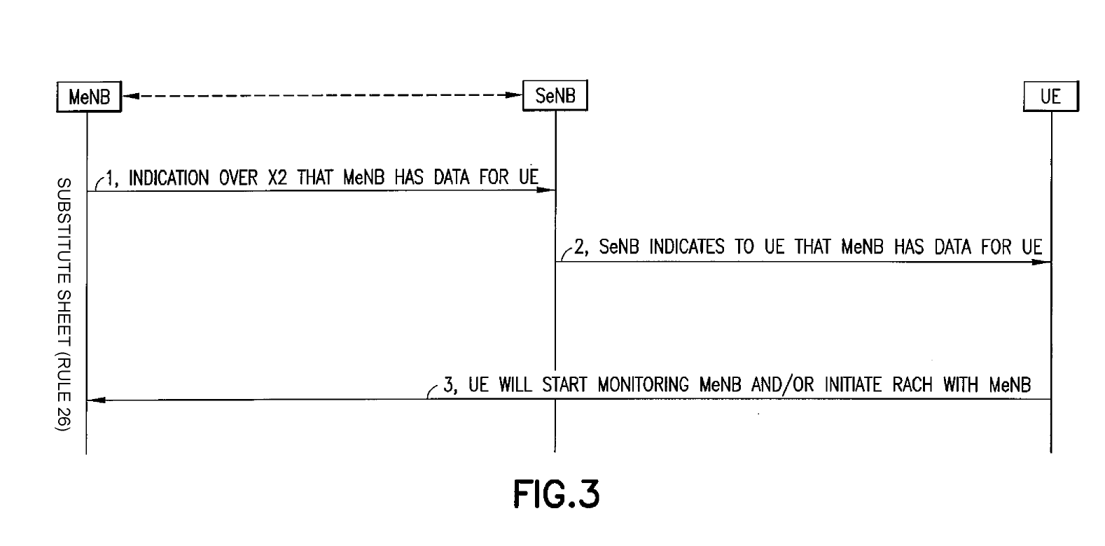

In FIG. 3 there is illustrated DRX related signaling in accordance with the exemplary embodiments of the invention. As shown in step 1 of FIG. 3 the MeNB, which may represent a PCell in this example, sends an indication to the SeNB, over an X2 interface for example, that the MeNB has data for the UE. In this step the MeNB may provide the SeNB with information to trigger transmission by the SeNB of an exemplary DRX related monitoring command to the UE. Then at step 2 of FIG. 3 in accordance with the exemplary embodiments the SeNB indicates to the UE with a type of monitoring command that the MeNB has data for it. The command to the UE may be using MAC or PDCCH signaling from the SeNB. Then as illustrated in step 3 of FIG. 3 the UE will in response to the signaling from the SeNB start to monitor a PDCCH from the MeNB and/or initiate a RACH with the MeNB.

As indicated above, there could be at least two options resulting from the signaling in accordance with the exemplary embodiments. As a possible first option there is, upon receiving the DRX monitoring command from the SeNB, the UE may monitor the PCell's PDCCH for x time (for example for a PDCCH order), where x may refer to milliseconds. In accordance with the exemplary embodiments of the invention the command from the SeNB may command or trigger the PDCCH monitoring by the UE. Further, the command may indicate the amount of the x time to perform the PDCCH monitoring by the UE. Also in a possible second option the command from the SeNB may instead, or in addition to the PDCCH command, instruct the UE to initiate and/or start RACH to the PCell or alternatively use scheduling request (possibly followed by empty BSR, or a specific MAC control element defined for this purpose) to signal the PCell that the UE is ready to receive in DL.

In accordance with the exemplary embodiments, for a case of the possible first option, the DRX cycle at the UE could be configured by higher layer configuration signaling. For the higher layer configuration an RRCConnectionReconfiguration message can be provided to the UE. The UE may be configured by the RRC message with a DRX functionality that controls/changes the DRX and thus the UE's PDCCH monitoring activity. In addition, when in RRC CONNECTED the UE is allowed to monitor the PDCCH discontinuously using the DRX operation. The RRC message can be used to configure the DRX timers including the onDurationTimer, drx-InactivityTimer, drx-RetransmissionTimer, the drxStartOffset and/or a drxShortCycleTimer and shortDRX-Cycle. Alternatively or additionally the PCell may signal UE for some other reason than reconfiguration of DRX parameters, for example, a handover to another cell or reconfiguration of one or more PSCell parameters.

Further, in accordance with the exemplary embodiments, the possible second option (or the first option) may be used in a case where UE loses an UL sync with PCell, when UE accesses the PCell by random access to resync its UL. It is noted that in case this sync is still valid (e.g. based on Time Alignment Timer TAT not being expired) in response to the command from the SeNB the UE may send a SR to the PCell that would indicate that it is ready to be scheduled in PCell. For example, when UE has lost UL sync (TAT expired), it may perform first random access and after that signal with SR. Optionally an empty BSR after that or some new MAC CE defined for this purpose. These are used for indicating PCell that UE is ready to receive. If UE has UL sync, it does not need random access, but can send SR directly. In addition, the UE may monitor the PCell for y time, where y may also refer to milliseconds. Further, similar to the case for the possible first option the command may indicate the amount of the y time to perform the monitoring of the PCell by the UE. In addition, the timing of x and y as indicated herein could also be according to other DRX configuration provided to the UE. Further, in accordance with the exemplary embodiments, after the time has elapsed the UE could send a BSR to indicate whether it has any UL data to send in the PCell (empty BSR indicating that there is no data in UL). Instead of or in addition to sending a BSR, the UE may send a new MAC control element or other signaling defined for this purpose of indicating that the UE is ready to be scheduled in PCell (and thus is monitoring the PDCCH).

One alternative to introduce this behavior is to enable MeNB and SeNB to communicate with each other so that for example MeNB (first cell/eNB) to poll when the UE is next time active under SeNB (2^{nd} cell/eNB) and if the activity occurs in 2^{nd} cell earlier than it would occur in first cell, second cell would trigger the first cell monitoring behavior. If the next scheduled occasion in 2^{nd} cell/eNB is later than in first cell/eNB or not within the given time window the 2^{nd} cell/eNB could convey that information to the first cell/eNB. Alternatively the process could be such that only positive acknowledgements are sent as a response by the 2^{nd} cell/eNB. This mechanism could be applied in either direction (also as a request from SeNB to MeNB). The information exchange could also be such that it would account information on the next scheduled activity to facilitate scheduling in the first cell.

Thus, in accordance with the exemplary embodiments the UE monitoring request and the command information exchange between the MeNB and the SeNB could be coordinated based on a known priori of a scheduled activity time of the UE in any of the cells to facilitate the information exchange scheduling.

Further, it should be mentioned that in the examples used for describing the idea although DC has been used for the connectivity by the UE to the different eNBs this does not limit the conceptual idea solely to DC. Similar approach may be applied also in other situation such as e.g. Dual Connectivity (DC) and a combination of DC and CA or in connection with future features like LTE-U/LAA etc. or future 5G systems. In such systems with potentially multiple small cell carriers, the invention could be extended for more than one (secondary) eNB. This could mean for example that one of the many cells could indicate UE to start monitoring (or transmit indication) in primary eNB. Or possibly, the indication could additionally include an identification of the cell/eNB the UE should start monitoring (or to which it should transmit indication such as SR); this can be useful if there is ambiguity due to more than one possible eNB that the UE could potentially start monitoring.

It is noted that in LTE and LTE-Advanced a focus has been on higher capacity. A driving force to further develop LTE is to provide higher bitrates in a cost efficient way. The main functionalities introduced include Carrier Aggregation (CA) and enhanced use of multi-antenna techniques. In CA each aggregated carrier is referred to as a component carrier. The component carrier can have a bandwidth of 1.4, 3, 5, 10, 15 or 20 MHz and multiple component carriers can be aggregated. The number of aggregated carriers can be different in DL and UL, and individual component carriers can be of different bandwidths. The exemplary embodiments of the invention can be applied to the benefit of a UE connected to a PCell and a PSCell using CA and implementing DRX at the PCell (MeNB) for example.

Some further details that could be used as alternatives in connection with the idea. Using CA and in view of how it works with PCell DRX one or more of the following can be performed:
Indication trigger monitoring for onDuration from the PSCell (SeNB). So when the trigger is received at the UE side the UE monitors the PCell for a duration of time equal to configured On-Duration;
Alternatively the UE may be configured to monitor the PCell for a duration of time equal to configured Short DRX, thus effectively entering Short DRX in PCell when signaling to start monitoring PCell is received from PSCell (SeNB);
Time during which the UE monitors can be given in MAC command from the PSCell or can be configurable based on the trigger or preconfigured at the UE;
If the UE is scheduled during the monitoring period the UE triggers/applies normal PCell DRX rules; and
If the UE is not scheduled during the monitoring period the UE may stop monitoring and may revert back to behavior applied from before receiving the command.

As can be seen the exemplary embodiments of the invention enable a power savings benefit with the use of a longer DRX cycle configuration at a cell of more than one cell connected to the UE whether the connection is using DC and/or CA.

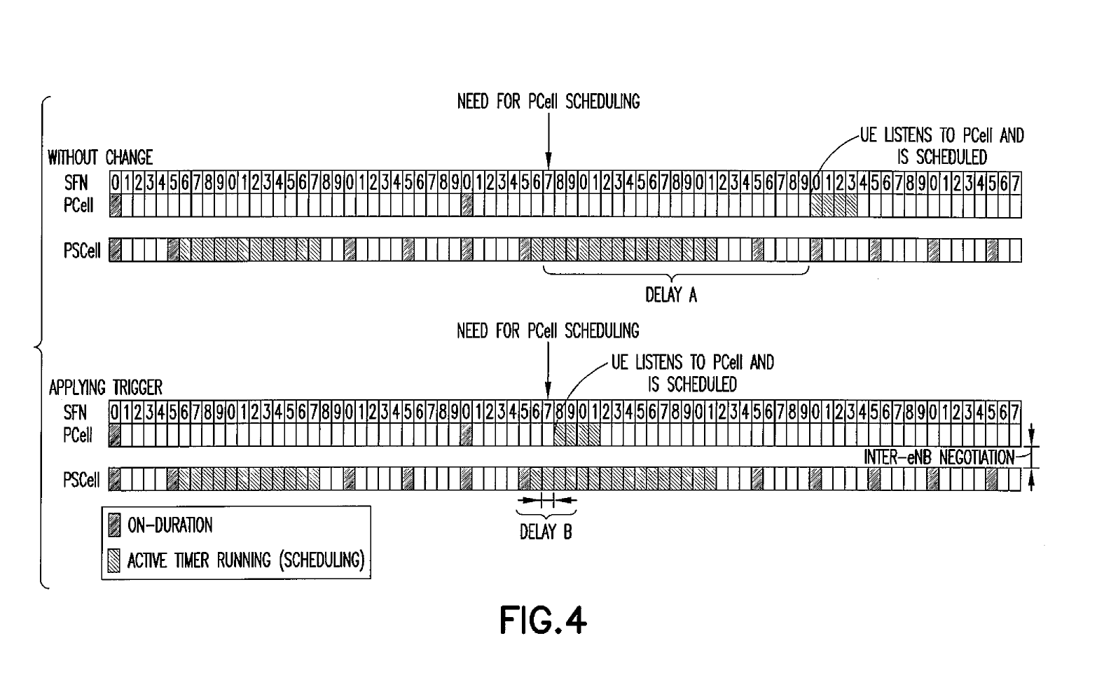

FIG. 4 illustrates the potential latency reduction when applying the method. In the example it is assumed that PCell is configured with long DRX for optimized UE power saving possibility while the UE is actively scheduled on the PSCell (in this case used for offloading).

As can be seen from FIG. 4 in a regular need for PCell scheduling with a regular DRX operation (without change) the PCell carrier has an on duration at SFN #0 of each frame, where the UE listens to the PCell during the last frame. In this scenario the PSCell has an on duration beginning at SFN #0 and SFN #5 of each frame, and in this scenario the UE listens to the PSCell only beginning at the SFN #5 of the first two frames. Thus, if scheduling is needed sooner there would be latency (Delay A). In accordance with the exemplary embodiments of the invention the PCell can benefit from the PSCell triggering the UE during one of the PSCell's scheduled listening periods to cause the UE to listen to the PCell. This can result in a significant potential gain in latency reduction in PCell scheduling. This operation, as in accordance with the exemplary embodiments, would also have a significant positive impact on the DC functionality. The improved functionality can be in terms of improved KPIs (with lowered failures like RLF, HOF's etc.), and reduced latency in reconfigurations of PSCell and PSCell management (PSCell changes).

For example, as shown in FIG. 4 in a different scenario (applying trigger) with an improved DRX operation the PCell signals the PSCell, as indicated by the inter-eNB negotiation, during SFN #7 of the second frame of the need for PCell scheduling for the UE. Then at SFN 8 and 9 of the second frame and 0 and 1 of the third frame the UE is triggered to listen to the PCell. Thus, the latency is greatly reduced (Delay B). In this example the delay is reduced by: Latency reduction=(Delay A)−(Delay B)

The actual gain of course depends on network configuration. In order to enable similar performance (in terms of control signaling latency and mobility robustness) in the current system without this method the monitoring on the PCell should always be rather continuous, which would increase UE power consumption because longer DRX cycles could not be used and thus reduce battery life and worsen the user experience. This approach will enable the possibility to ensure good UE power savings by reduced PCell monitoring. The actual PCell monitoring would now only be triggered (network controlled) when there is a real need for UE to monitor the PCell. In other cases PCell monitoring would be less efficient depending on how frequently scheduled.

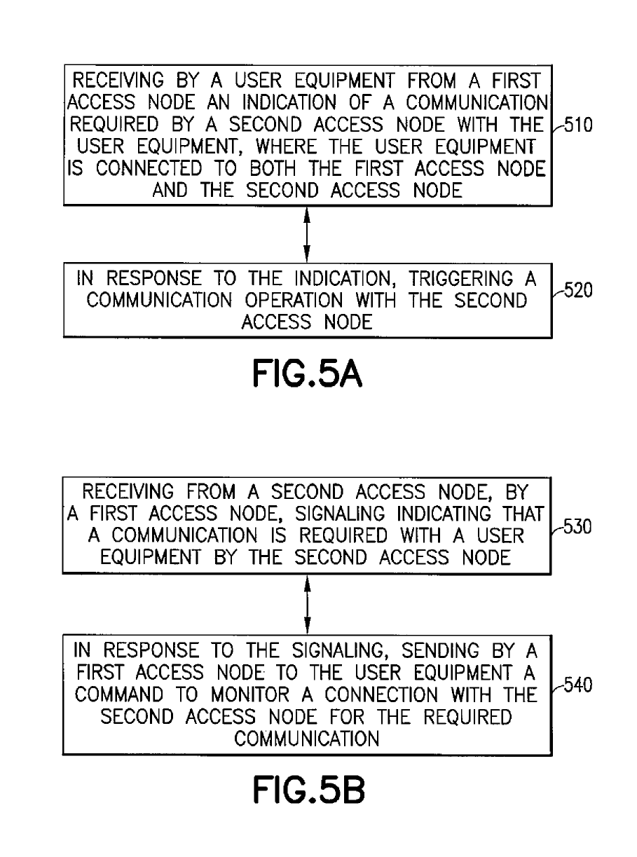

FIG. 5A illustrates operations which may be performed by a network device such as, but not limited to, UE (e.g., the UE 100 as in FIG. 2). As shown in step 510 of FIG. 5A, there is receiving by a user equipment from a first access node an indication of a communication required by a second access node with the user equipment, where the user equipment is connected to both the first access node and the second access node. At step 520 there is in response to the indication, triggering at the user equipment a connectivity operation with the second access node.

In accordance with the exemplary embodiments as described in the paragraphs above, the first access node comprises a PSCell base station, and the second access node comprises a PCell base station.

In accordance with the exemplary embodiments as described in the paragraph above, the triggering the connectivity operation comprises implementing a short discontinuous reception cycle timer.

In accordance with the exemplary embodiments as described in the paragraphs above, a duration of the short discontinuous reception cycle tinier was received by the user equipment from the second access node.

In accordance with the exemplary embodiments as described in the paragraphs above, the duration of the short discontinuous reception cycle timer was received by the user equipment in a radio resource control message.

In accordance with the exemplary embodiments as described in the paragraphs above, the connectivity operation comprises the user equipment initiating a random access procedure with the second access node.

In accordance with the exemplary embodiments as described in the paragraphs above, the connectivity operation comprises monitoring a physical downlink control channel from the second access node for a period of time for signaling from the second access node.

In accordance with the exemplary embodiments as described in the paragraphs above, the period of time is provided to the user equipment by the first access node in control signaling with a medium access control command.

In accordance with the exemplary embodiments as described in the paragraphs above, the period of time is preconfigured in the user equipment.

In accordance with the exemplary embodiments as described in the paragraphs above, the connectivity operation comprises initiating by the user equipment a random access channel scheduling request to the second access node.

In accordance with the exemplary embodiments as described in the paragraphs above, the connection comprises a radio resource control connected state established between the user equipment and each of the first access node and the second access node.

In accordance with the exemplary embodiments as described in the paragraphs above, the connection to both the first access node and the second access node is using carrier aggregation.

In accordance with an exemplary embodiment of the invention as described above there is an apparatus comprising: means for receiving by a user equipment [UE100] from a first access node [eNB 200 or 220] an indication of a communication required by a second access node [eNB 200 or 220] with the user equipment [UE100], where the user equipment is connected to both the first access node and the second access node; and means in response to the indication, for triggering at the user equipment a connectivity operation with the second access node.

In the exemplary aspect of the invention according to the paragraph above, wherein the means for receiving and triggering comprises a non-transitory computer readable medium [MEM 204, 224, and/or 254] encoded with a computer program [PROG 208, 228, and/or 258]; and/or [Data 206, 226, and 256] executable by at least one processor [DP 202, 222, and/or 252].

FIG. 5B illustrates operations which may be performed by a network device such as, but not limited to, an eNB (e.g., the PSCell eNB as in FIGS. 1 and 2). As shown in step 530 of FIG. 5b, there is receiving from a second access node, by a first access node, signaling indicating that a communication is required with a user equipment by the second access node. At step 540 there is in response to the signaling, sending by a first access node to the user equipment a command to monitor a connection with the second access node for the required communication.

In accordance with the exemplary embodiments as described in the paragraph above, the user equipment is connected to the second access node.

In accordance with the exemplary embodiments as described in the paragraphs above, the signaling from the second access node is received over an X2 interface of the first access node.

In accordance with the exemplary embodiments as described in the paragraphs above, the signaling comprises discontinuous reception pattern and cycle information to send to the user equipment.

In accordance with the exemplary embodiments as described in the paragraphs above, the first access node is a master base station and where the second access node is a secondary base station.

In accordance with the exemplary embodiments as described in the paragraphs above, the first access node is in a first cell and where the second access node is in a second cell of a communication network.

In accordance with the exemplary embodiments as described in the paragraphs above, there is polling the user equipment to determine a next active time of the user equipment with the second access node, wherein the command to monitor the connection with the second access node is sent only if it is determined that activity by the first access node with the user equipment is before the next active time of the user equipment with the second access node.

In accordance with an exemplary embodiment of the invention as described above there is an apparatus comprising: means for receiving from a second access node [eNB 200 or 220], by a first access node [eNB 200 or 220], signaling indicating that a communication is required with a user equipment by the second access node. At step 540 there is in response to the signaling, sending by a first access node to the user equipment a command to monitor a connection with the second access node for the required communication.

In the exemplary aspect of the invention according to the paragraph above, wherein the means for receiving and signaling comprises a non-transitory computer readable medium [MEM 204, 224, and/or 254] encoded with a computer program [PROG 208, 228, and/or 258]; and/or [Data 206, 226, and 256] executable by at least one processor [DP 202, 222, and/or 252].

The apparatus may be, include or be associated with at least one software application, module, unit or entity configured as arithmetic operation, or as a computer program or portions thereof (including an added or updated software routine), executed by at least one operation processor, unit or module. Computer programs, also called program products or simply programs, including software routines, applets and/or macros, may be stored in any apparatus-readable data storage medium. A computer program product may comprise one or more computer-executable components which, when the program is run, are configured to carry out embodiments described above by means of FIGS. 5A and/or 5B. Additionally, software routines may be downloaded into the apparatus.

The apparatus, such as a node or user device, or a corresponding component, may be configured as a computer or a microprocessor, such as single-chip computer element, or as a chipset, including or being coupled to a memory for providing storage capacity used for software or arithmetic operation(s) and at least one operation processor for executing the software or arithmetic operation(s).

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-41. (canceled)

42. A method comprising:
receiving by a user equipment from a first access node an indication of a communication required by a second access node with the user equipment, where the user equipment is connected to both the first access node and the second access node; and
in response to the indication, triggering at the user equipment a connectivity operation with the second access node.

43. The method of claim 42, wherein the first access node comprises a PSCell base station, and the second access node comprises a PCell base station.

44. The method of claim 42, wherein triggering the connectivity operation comprises implementing a short discontinuous reception cycle timer.

45. The method of claim 44, where a duration of the short discontinuous reception cycle timer was received by the user equipment from the second access node.

46. The method of claim 45, where the duration of the short discontinuous reception cycle timer was received by the user equipment in a radio resource control message.

47. The method of claim 42, where the connectivity operation comprises initiating by the user equipment a scheduling request to the second access node.

48. The method of claim 42, where the connection comprises a radio resource control connected state established between the user equipment and each of the first access node and the second access node.

49. The method of claim 42, where the connection to both the first access node and the second access node is using carrier aggregation.

50. An apparatus comprising:
at least one processor; and
at least one memory including compute program instructions,
wherein the at least one memory and computer program instructions are configured to, with the at least one processor, cause the apparatus at least to:
receive from a first access node an indication of a communication required by a second access node with the apparatus, where the apparatus is connected to both the first access node and the second access node; and
in response to the indication, trigger a connectivity operation with the second access node.

51. The apparatus of claim 50, wherein the first access node comprises a PSCell base station, and the second access node comprises a PCell base station.

52. The apparatus of claim 50, wherein triggering the connectivity operation comprises implementing a short discontinuous reception cycle timer.

53. The apparatus of claim 52, where a duration of the short discontinuous reception cycle timer was received from the second access node.

54. The apparatus of claim 53, where the duration of the short discontinuous reception cycle timer was received in a radio resource control message.

55. The apparatus of claim 50, where the connectivity operation comprises initiating by the apparatus a random access channel scheduling request to the second access node.

56. The apparatus of claim 50, where the connection comprises a radio resource control connected state established between the apparatus and each of the first access node and the second access node.

57. The apparatus of claim 50, where the connection to both the first access node and the second access node is using carrier aggregation.

58. An apparatus comprising:
at least one processor; and
at least one memory including compute program instructions,
wherein the at least one memory and computer program instructions are configured to, with the at least one processor, cause the apparatus at least to:
receive, from a second access node, signaling indicating that a communication is required with a user equipment by the second access node; and
in response to the signaling, send to the user equipment a command to monitor a connection with the second access node for the required communication.

59. The apparatus of claim 58, where the signaling comprises discontinuous reception pattern and cycle information to send to the user equipment.

60. The apparatus of claim 58, where the apparatus is a secondary base station and where the second access node is a master base station.

61. The apparatus of claim 58, where the apparatus is in a first cell and where the second access node is in a second cell of a communication network.
